(19) United States
(12) Patent Application Publication
(10) Pub. No.: US 2022/0414784 A1
(43) Pub. Date: Dec. 29, 2022

(54) BLOCK PREDICTION TOOL FOR ACTUARIES

(71) Applicant: Assured Inc., Wellesley, MA (US)

(72) Inventors: Yehonatan YEDIDIA, Tel Aviv (IL); Yariv Dror MIZRAHI, Ra'anana (IL); Afik GAL, Needham, MA (US)

(21) Appl. No.: 17/851,067

(22) Filed: Jun. 28, 2022

Related U.S. Application Data
(60) Provisional application No. 63/216,000, filed on Jun. 29, 2021.

(51) Int. Cl. G06Q 40/08; G06N 5/02

(52) U.S. Cl. CPC G06Q 40/08; G06N 5/02

(57) ABSTRACT

A block prediction tool for actuaries includes a parametric model definer, a parametric model-based predictor and a robustness checker. The parametric model definer enables an actuary to define an initial parametric model. The predictor generates a current model by finding parameters for the initial parametric model which provide a match to data of an insurance block and produces a prediction for the insurance block using the current model. The robustness checker checks a robustness of the current model with respect to stochastic noise, parametric noise and time stability individually and in combination and generates an overall risk-level for the insurance block therefrom.

### CROSS REFERENCE TO RELATED APPLICATIONS

This application claims priority from U.S. provisional patent application 63/216,000, filed Jun. 29, 2021, which is incorporated herein by reference.

### FIELD OF THE INVENTION

The present invention relates to tools for actuaries generally and for life insurance actuaries in particular.

### BACKGROUND OF THE INVENTION

An actuary at a life insurance company produces financial projections of expected claims in the future (such as 1 year, 10 years, 50 years in the future) on a block of life insurance policies (a set of policies that the insurance company buys, sells or maintains together) that the insurance company has issued. Each block includes many records about the insurance policies, where the data typically includes information about the policy owners (bibliographic information such as name, address, and other identifying information), information about the insurance policy (type of policy, its length, its conditions, amount to pay per claim, etc., and some medical information (age at buying the policy, age when making a claim, results of medical exam upon joining the policy, etc.) and possibly some other information, such as marital status.

The actuary builds different actuarial models of the data of the block based on different expected outcomes, such as incidence, lapse, etc. The actuary typically operates on spreadsheets or may use some basic algorithm and may verify the model using an A/E (actual vs. expected) analysis or with an outside actuarial software (e.g., AXIS) to produce a complete final result.

This is a very time consuming and cumbersome process, which leads to limited modeling. And the modeling which is done is imprecise and lacks in statistical rigor.

For example, spreadsheets or table-like models are strongly dependent on features defined by the categories in the data. Moreover, the models do not pass information between categories and most data features that a model may have participate through multipliers only.

A/E analyses, on the other hand, are prone to overfit and might indicate that a model is bad when it's good and vice versa. As a result, actuaries tend to use it to match their “gut feeling”.

### SUMMARY OF THE PRESENT INVENTION

There is therefore provided, in accordance with a preferred embodiment of the present invention, a block prediction tool for actuaries implemented on a computing unit. The block prediction tool includes a parametric model definer, a parametric model-based predictor and a robustness checker. The parametric model definer enables an actuary to define an initial parametric model. The parametric model-based predictor finds parameters for the initial parametric model which provide a match to data of an insurance block, generates therefrom a current model, and produces a prediction for the insurance block using the current model. The robustness checker checks a robustness of the current model with respect to stochastic noise, parametric noise and time stability individually and in combination and generates an overall risk-level for the insurance block therefrom. The parametric model definer enables the actuary to define further initial parametric models and to activate the parametric model-based predictor and the robustness checker on them.

Moreover, in accordance with a preferred embodiment of the present invention, the parametric model-based predictor includes a variable checker, a trainer and a predictor. The variable checker selects variables of the initial parametric model to include in a model-to-be-checked. The trainer determines coefficients for the model-to-be-checked which match the data and provides a quality level of the match to the variable checker. The variable checker generates further models-to-be-checked and to select one as the current model. The predictor generates the prediction for the data using the current model.

Further, in accordance with a preferred embodiment of the present invention, the robustness checker includes a stochastic noise distribution estimator, a parametric noise distribution estimator, a time stability distribution estimator, and a robustness estimator. The stochastic noise distribution estimator determines how changes in the data affect the prediction. The parametric noise distribution estimator indicates how changes in the coefficients affect the prediction. The time stability distribution estimator indicates how changes in periods of time of the data affect the prediction; and the robustness estimator estimates the overall risk-level of the current model to integrated changes in the data, in the coefficients and in the periods of time affect the prediction.

Finally, in accordance with a preferred embodiment of the present invention, the time stability distribution estimator includes a yearly transition table selector to combine the data with external mortality tables to generate a plurality of transition tables, each for a particular range of years of data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustration of a block prediction tool, constructed and operative in accordance with a preferred embodiment of the present invention;

FIG. 2 is a block diagram illustration of a parametric predictor forming part of the tool of FIG. 1;

FIG. 3 is a block diagram illustration of a stochastic noise distribution estimator forming part of the tool of FIG. 1;

FIG. 4 is a block diagram illustration of a parametric noise distribution estimator forming part of the tool of FIG. 1;

FIG. 5 is a block diagram illustration of a time stability distribution estimator forming part of the tool of FIG. 1; and

FIG. 6 is a block diagram illustration of a robustness estimator forming part of the tool of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that insurance actuaries need a tool to enable them to easily select a model for a block of insurance policies (a set of policies that the insurance company buys, sells or maintains together), to verify how well the model matches the data of the block and then to use the selected model to determine the risk level of the block. Determining the risk level or other results (financial projections, incidence, death, lapse, utilization, disabled mortality, disabled recovery, etc.) of a block is the “holy grail” of insurance companies and the present invention is a tool to provide produce such an output.

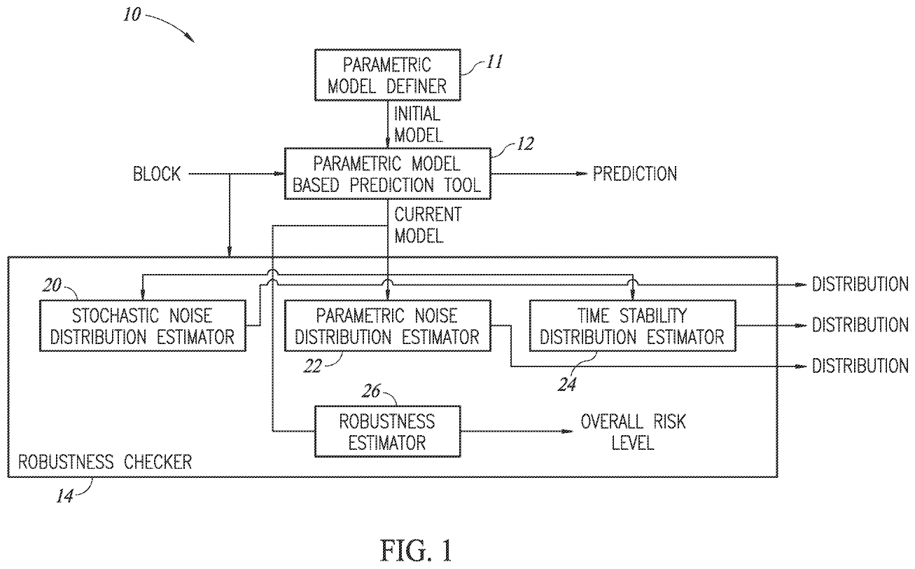

Reference is now made to FIG. 1, which illustrates a block prediction tool 10, constructed and operative in accordance with a preferred embodiment of the present invention. Tool 10 comprises a parametric model definer 11, a parametric model-based predictor 12 and a robustness checker 14. Parametric model definer 11 may have a parametrized model (i.e. a function with many parameters) of many variables and may enable an actuary to change which variables or features are to be included in an initial model. For example, the model may be a function of the following type:

$$\frac{exp ( \sum {α}_{1} Var 1 + {α}_{2} Var 2 + {α}_{3} Var 3 + … )}{1 + exp ( {age}^{2} + \sum {α}_{1} Var 1 + {α}_{2} Var 2 + {α}_{3} Var 3 + … )} \qquad ( equation 1 )$$

Where the αᵢ' are coefficients (i.e. the parameters to be selected) and Var1, Var2, etc. are variables (i.e. the data of the block). For example, Var1 may be “height” of the insured person and Var2 may be “city” where the insured person lives. Coefficients αᵢ are the parameters to be determined.

For example, for a small block of only 10,000 “policy years”, the best model (i.e. one which matches the data best and which provides the best prediction) may only have a few variables to it while for a larger block, of 5000 policies, the best model may have more variables. In one example, the model of the small block may be according to the following table:

| Variable | Coefficient |
|---|---|
| Age | 0.7246 |
| Gender_M | −0.1097 |
| Benefit_period | 0.1025 |
| Constant | −3.5103 |

In an example of a large block of 700,000 policy years, the model might be according to the following table:

| Variable | Coefficient |
|---|---|
| Age | 1.0127 |
| Gender_M | −.0717 |
| NF_Status_Y | −0.3601 |
| Elimination_period | −0.1194 |
| Daily_benefit | 0.0815 |
| Spousal_discount | −0.0489 |
| Age_sq | −0.1213 |
| Constant | −3.-3.6205 |

For the larger block, more variables may be used to match the data and provide the best prediction. Which variables are used is a function of what variables are available (not all blocks have all types of variables) and how the variables affect the predictions.

Definer 11 may include an input unit to enable the actuary to force a coefficient of a particular variable to be 0, so that the variable it multiplies will not be included in the model.

Predictor 12 may find the values of the parameters of the initial model which best matches the data of the block.

As described in more detail hereinbelow, predictor 12 may determine the values of the coefficients that give the best match to the data and may then use the resultant model (called the “current model”) to generate a prediction of the results of the block.

Robustness checker 14 may check the effect of multiple types of noise on the current model and may determine the general robustness of the current model. For example and as described in more detail hereinbelow, robustness checker 14 may comprise a stochastic noise distribution estimator 20, a parametric noise distribution estimator 22, a time stability distribution estimator 24, to check the current model against stochastic noise, parametric noise, and time stability, and may provide distribution projections for each. In addition, robustness checker 14 may comprise a robustness estimator 26 to estimate the robustness of the current model and may generate therefrom an overall risk level associated with the current model and its prediction.

Definer 11, predictor 12 and robustness checker 14 together may allow an actuary to quickly change the model (typically by changing which variables are to be included in it), to see how the prediction changes and how robust each of the models are, which may enable the actuary to gain insight into the data of the block.

It will be appreciated that tool 10 may generate a picture of the quality of the current model and may do so for each of the different models for the block that the actuary may check. For each model, tool 10 may generate both a prediction, such as of the cost of the block of policies, projection distributions, which may define variations around the prediction, and an overall risk level. For example, while small blocks will yield big variation, regardless of which model was selected, tool 10 may enable an actuary to determine which model may have the least variation.

The prediction and risk level are important for life insurance companies who are required to reserve enough money to cover the cost of the block. The amount of money required is a function of the prediction and the risk level. Clearly, the lower the risk level, the less money has to be reserved. The distributions caused by the various types of noise provide a level of certainty to the prediction and risk level as well as indicating the type of noise which may be of concern. As long as all of the distributions are relatively small, the prediction and risk level are unlikely to change.

Tool 10 may be particularly useful for long term care (LTC) insurance blocks. However, it may be utilized for life insurance and disability insurance as well as other types of insurances.

It will be appreciated that, since block prediction tool 10 may relatively easily provide a picture of robustness for each model the actuary may check, tool 10 may enable the actuary to determine which model matches the block best, both in terms of a match to the data and in terms of its robustness. Moreover, block prediction tool 10 may provide relatively quick feedback to the actuary both on the quality of the model's fit to the data as well as on the robustness of the model.

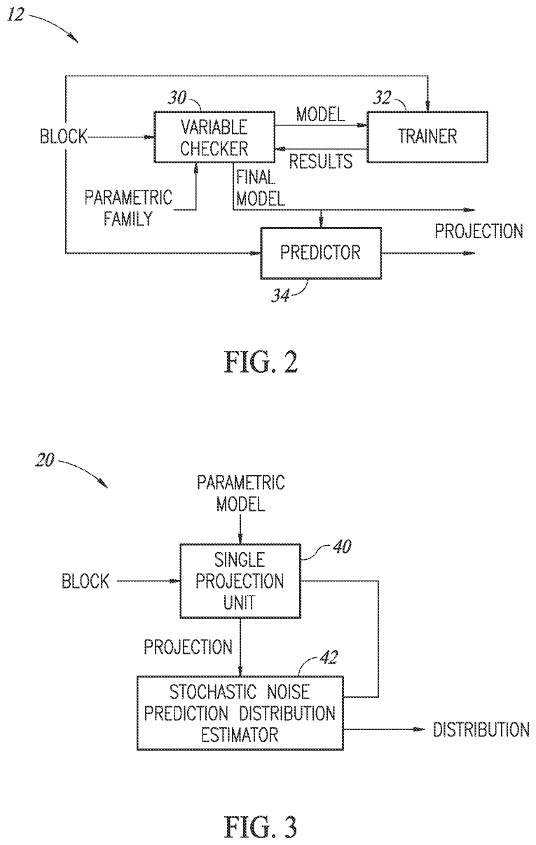

Reference is now made to FIG. 2, which details the elements of parametric predictor 12. Predictor 12 comprises a variable checker 30, a trainer 32 and a predictor 34 and receives as input the data of the block (i.e. the values of the variables for each policy and the result or actions that occurred on that policy). This data is provided to variable checker 30, trainer 32 and predictor 34.

Parametric model definer 11 may provide the type of parametric model selected by the actuary , which the actuary expects will match the variables to the results of the block, to variable checker 30. The parametric model may be any type of model with to-be-determined coefficients, such as a linear, a non-linear, a quadratic model or a model of the type of equation 1.

Parametric model definer 11 may also provide the variables of the block which the actuary indicated may be included in the model and/or which variables should not be included in the model. Variable checker 30 may check the selected parametric model by first selecting one of the variables indicated by the actuary, and instructing trainer 32, which may be a gradient descent algorithm, to determine the coefficients of the model which best match the data of the block to the model with the selected variable. Trainer 32 may provide these coefficients to variable checker 30 which, in turn, may generate the values of each record according to the model and may compare the generated values with the actual data of the block. From this, variable checker 30 may determine a resultant error for the current model.

If the resultant error is large, then the current model does not model the data of the block well. Variable checker 30 may enable the actuary to approve the current model or to disapprove it, forcing variable checker 30 to add another variable (automatically selected or selected by the actuary) into the model and to repeat the process until the error is sufficiently low. In this manner, variable checker 30 may select the variables which give the least error. The final model may be a set of coefficients for the selected variables of the parametric model.

Once the actuary has approved the model, variable checker 30 may provide the final model to predictor 34 which may use the final model to determine the projection (i.e. expected results) on the data of the block. Variable checker 30 may also provide the final model to robustness checker 14.

It will be appreciated that variable checker 30 may be a “one-by-one” algorithm and may calculate the contribution of each variable separately. Variable checker 30 may select the variable which best matched the data as a first variable of the model and may then attempt to determine a second variable of the model, by separately adding each of the remaining variables. Variable checker 30 may add the best of the second variables if some numerical criterion indicates that the current model is “better” than the previous one. The process may continue searching for additional variables until the results of none of the additional variables significantly improve the current model. Variable checker 30 may utilize naive likelihood scores (with attenuation) or cross validation or with L2 scores or weighted L2 scores.

It will be appreciated that this embodiment assumes that the variables are independent. Alternatively, variable checker 30 may rank all of the variables (or features) and may only utilize those whose rank is larger than 1.

In an alternative embodiment, variable checker 30 may utilize an L2 metric, which may indicate which variable explains the data best (i.e. by measuring the error). For this, variable checker 30 may add variables one at a time, but once this is done, may also recompute the contribution of all the variables. Variable checker 30 may measure the error or the score with different metrics, such as an L2 or a weighted L2, and may select the variables which minimize the score. Variable checker 30 may compare the scores of the variables calculated by L2 to see if one of them provides a real improvement.

In general, variable checker 30 may operate on data from the early years of the block and may use the resultant model to predict the results from the later years of the block. It may enable the actuary to check the data and to determine which features or variables have a greater effect on the data for a given result (such as incidence, mortality, etc.) and to “weed out” features which are unlikely to affect a statistical model. Alternatively, if a result is suspected to derive from some other feature, this hypothesis can be tested by changing parameter (or coefficient) values per feature before finalizing the parameter selection.

Reference is now made to FIG. 3, which illustrates the elements of stochastic noise distribution estimator 20 of robustness checker 14. Stochastic noise distribution estimator 20 may provide a sense of how the changes in the data may affect the outcome of the model. Accordingly, estimator 20 comprises a single projection unit 40 and a stochastic noise prediction distribution estimator 42. Single projection unit 40 may receive the final model from parametric predictor 12 and the block of data and may activate single projection unit 40 multiple times on a part of the data not used by variable checker 30 for the model calculation, such as the later years of data. For each activation, single projection unit 40 may randomly decide what happens for each person in the block, for each year, and may generate a projection with this version of the data according to the final model. Thus, each activation may have its associated projection and its result based on the final model.

When all iterations are finished, stochastic noise prediction distribution estimator 42 may receive the multiple projections and results and may determine the stochastic noise (e.g. the expected error and the standard deviation) in the model.

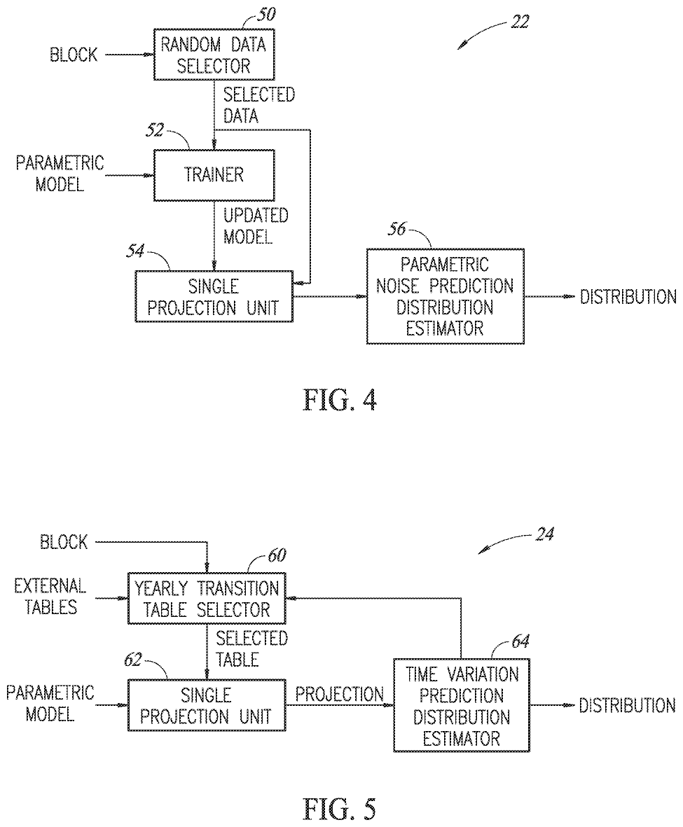

Reference is now made to FIG. 4, which illustrates the elements of parametric noise distribution estimator 22. Estimator 22 may provide a sense of how the coefficients may affect the outcome of the model. To this end, estimator 22 may comprise a random data selector 50, a trainer 52, a single projection unit 54 and a parametric noise prediction distribution estimator 56.

Estimator 22 may receive the block of data and the final model from parametric predictor 12 and may activate random data selector 50 multiple times, each time to select a different portion of the block. Typically each portion may include about 70% of the data of the block.

For each iteration, trainer 52 may operate similarly to trainer 32 of variable checker 30 and may determine the coefficients of the model which best match the data of the current portion of the block to the model. Trainer 52 may thus generate an updated model (with changed coefficients only) based on the selected portion of the block. Single projection unit 54 may, in turn, generate a projection of the updated parametric model for the selected data.

Estimator 22 may activate random data selector 50, trainer 52 and single projection unit 54 for each iteration. When all the iterations are finished, parametric noise prediction distribution estimator 56 may determine the distribution (e.g. the error and the standard deviation) of the parametric noise in the model.

Reference is now made to FIG. 5, which illustrates the elements of time stability distribution estimator 24. Estimator 24 may provide a sense of how changes in the time period may affect the outcome of the model. To this end, estimator 24 may comprise a yearly transition table selector 60, a single projection unit 62 and a time variation prediction distribution estimator 64.

Yearly transition table selector 60 may combine the data from the block with external data, such as the mortality tables in the US per year, to generate a plurality of transition tables, each for a particular range of years of data. The tables define how mortality changes over many years and are useful for extending the projection since the block data typically covers only a few years.

Estimator 24 may activate transition table selector 60 multiple times, each time to select the table describing a different set of years of data from those in the block. For each transition table, estimator 24 may activate single projection unit 62 to generate a projection of the final model on the transition table.

When all iterations are finished, time stability distribution estimator 24 may determine the distribution (e.g. the error and the standard deviation) of the time variation in the model.

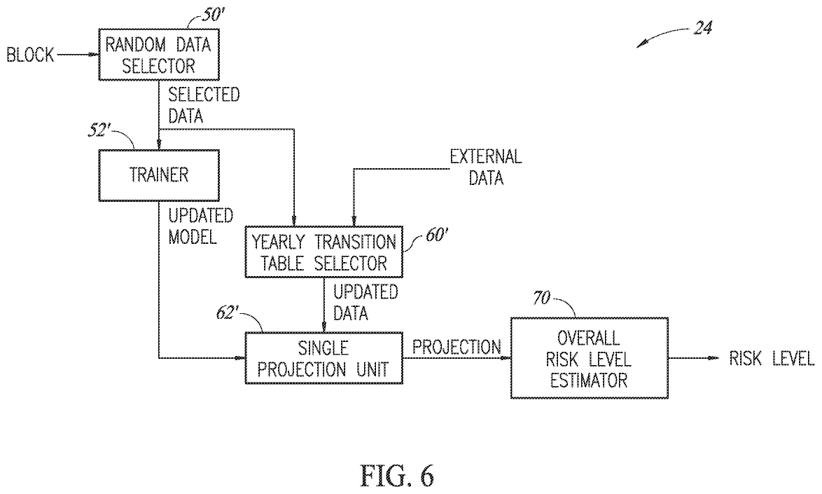

Robustness checker 14 may combine the distribution output of estimators 20, 22 and 24, typically in a table, and may activate robustness estimator 26, whose details are shown in FIG. 6, to which reference is now made.

Robustness estimator 26 may provide an integrated distribution check by combining the methods of the individual estimators 20, 22 and 24. Thus, it may have a parametric noise check with random data selector 50′ and trainer 52′ which may select a portion (about 70%) of the data and may generate an updated model for that portion, a time stability check with yearly transition table selector 60′ which may combine the selected data with external data and may select a different set of years of data from those in the portion, and a stochastic noise check with single projection unit 62′ which may randomly decide what happens for each person in each year in the new set of years and may run the updated model on the random data to produce an integrated projection.

Robustness estimator 26 may run random data selector 50′, trainer 52′, yearly transition table selector 60′ and single projection unit 62′ a large plurality, such as 10,000, times, and at each iteration may make all 3 types of changes. Robustness estimator 26 may additionally comprise an overall risk level estimator 70, which may combine the results of the large plurality of runs to generate an overall distribution (error and standard deviation) which may define the risk level of the block.

It will be appreciated that robustness estimator 26 may provide a sense of how all three changes (time, stochastic noise, and parameters) affect the outcome.

It will be appreciated that viewing the output of robustness checker 14 per model may give an understanding to the actuary of the strengths and weaknesses of different models. Moreover, since robustness checker 14 produces four different measures of robustness, it may enable the actuary to see how robust the models produced therefrom are. This may be especially important for sparse data or small blocks, which, as mentioned hereinabove are not easily modeled.

It will also be appreciated that, in tool 10, recalculating models while parametric model-based predictor 12 is defining the current model and after each parameter change in robustness checker 14 takes relatively little time (between a millisecond and several minutes at most on any standard desktop computer, thus drastically improving the overall process.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A block prediction tool for actuaries implemented on a computing unit, the block prediction tool comprises:
a parametric model definer to enable an actuary to define an initial parametric model;
a parametric model-based predictor to find parameters for said initial parametric model which provide a match to data of an insurance block to generate a current model, and to produce a prediction for said insurance block using said current model; and
a robustness checker to check a robustness of said current model with respect to stochastic noise, parametric noise and time stability individually and in combination and to generate an overall risk-level for said insurance block therefrom,
said parametric model definer to enable said actuary to define further initial parametric models and to activate said parametric model-based predictor and said robustness checker on them.

2. The block prediction tool according to claim 1 and wherein said parametric model-based predictor comprises:
a variable checker to select variables of said initial parametric model to include in a model-to-be-checked;
a trainer to determine coefficients for said model-to-be-checked which match said data and to provide a quality level of said match to said variable checker,
said variable checker to generate further models-to-be-checked and to select one as said current model; and
a predictor to generate said prediction for said data using said current model.

3. The block prediction tool according to claim 2 and wherein said robustness checker comprises:
a stochastic noise distribution estimator to determine how changes in said data affect said prediction;
a parametric noise distribution estimator to indicate how changes in said coefficients affect said prediction;
a time stability distribution estimator to indicate how changes in periods of time of said data affect said prediction; and
a robustness estimator to estimate said overall risk-level of said current model to integrated changes in said data, in said coefficients and in said periods of time affect said prediction.

4. The block prediction tool according to claim 3 and wherein said time stability distribution estimator comprises a yearly transition table selector to combine said data with external mortality tables to generate a plurality of transition tables, each for a particular range of years of data.
